(19) United States
(12) Patent Application Publication
(10) Pub. No.: US 2016/0113267 A1
(43) Pub. Date: Apr. 28, 2016

(54) BARRIER

(71) Applicant: Craig Justin MOSS, Kingsley (AU)

(72) Inventor: CRAIG JUSTIN MOSS, KINGSLEY (AU)

(73) Assignee: CRAIG JUSTIN MOSS, KINGSLEY (AU)

(21) Appl. No.: 14/894,840

(22) PCT Filed: Jun. 2, 2014
(86) PCT No.: PCT/AU2014/000573

§ 371 Date: Nov. 30, 2015

(30) Foreign Application Priority Data
May 31, 2013 (AU) 2013901977
Jan. 10, 2014 (AU) 2014900084

(51) Int. Cl. A01M 29/30; E02B 1/00; A01K 61/00

(52) U.S. Cl. CPC A01M 29/30; A01K 61/00; E02B 1/006

(57) ABSTRACT

A barrier, such as a shark barrier, comprising a plurality of pylons spaced apart with respect to each other, and a mesh extending between the pylons wherein the mesh comprises a plurality of modules adapted to be attached to each other. In an arrangement the mesh is adapted to adjust to account for tidal changes and movement of water. The modules of the mesh may be pivotally attached to each other and the mesh may be adapted to selectively be displaced between an extended condition and a contracted condition.

### TECHNICAL FIELD

The present invention relates to barrier

The invention has been devised particularly, although not necessarily solely, in relation to shark barriers.

### BACKGROUND ART

The following discussion of the background art is intended to facilitate an understanding of the present invention only. The discussion is not an acknowledgement or admission that any of the material referred to is or was part of the common general knowledge as at the priority date of the application.

When swimming in the ocean in open water, there is always the risk of being attacked by a shark. Given a significant number of shark attacks in Australian waters in recent years, there is an increasing need to assess the options available for reducing this risk.

Barriers provided around areas of beaches to limit access by sharks have been employed in certain locations. These barriers have generally comprised netting extended around the swimming areas. Such shark nets however have a number of disadvantages.

Firstly, while flexible rope netting can reduce the likelihood of sharks entering the area, it also poses a danger to both the sharks and other marine life. Many sea creatures are killed due to being caught in the netting and being unable to escape. Further, flexible rope type netting can also be damaged and requires regular maintenance to ensure holes don't develop which would reduce its effectiveness.

Moreover, typically shark barrier need to be relative strong to sustain any damage due to possible contact with sharks. However, any shark barrier needs to be relatively flexible allowing the barrier to contract, expand and bend to account for tidal changes.

Further, on occasions it may be desired that the barrier be removed. For example, the barrier may be removed during seasons where there are low numbers of sharks or one at all or the sharks have migrated to other regions. And, thus, the shorelines are save to use with a shark barrier.

Also, the barriers may need to be removed to allow access from the coast to the open sea or vice versa. For example, the barrier may need to be removed during water sport events. Typically, removal of barriers such as a rope netting is time consuming and cumbersome.

It is against this background that the present invention has been developed.

SUMMARY OF INVENTION

According to a first aspect of the present invention there is provided a barrier comprising a plurality of pylons spaced apart with respect to each other, and a mesh extending between the pylons wherein the mesh comprises a plurality of modules adapted to be attached to each other.

Preferably, the barrier further comprises a rope extending between the pylons for attachment of an upper portion of the mesh to maintain the mesh in the extended condition.

Preferably, the barrier further comprises a first chain extending between the pylons for attachment of a lower portion of the mesh to secure the mesh to a lower portion of the barrier.

Preferably, at least one module of the mesh is attached to the first chain.

Preferably, the barrier comprises means for anchoring the barrier to the seabed.

Preferably, the means for anchoring the barrier comprises at least one second chain, the second chain being anchored to the seabed at locations distal to the barrier.

Preferably, the second chain extends perpendicular to the barrier.

Preferably, the second chain comprises two ends, the two ends being anchored to the seabed via anchors.

Preferably, the second chain is attached to the first chain of the barrier.

Preferably, the mesh is adapted to account for movement of water in which the barrier is at least partially immersed.

Preferably, at least two modules are pivotally attached to each other.

Preferably, adjacent rows of modules are pivotally attached to each other.

Preferably, adjacent columns of modules are pivotally attached to each other.

In an arrangement, there is provided a plurality of the two modules pivotally attached to each other, the plurality of the two modules extending longitudinally along the mesh to define a column that separates the mesh into a first section of the mesh and a second section of the mesh wherein the first section is pivotally attached to the second section of the mesh to allow curving of the mesh along the transversal direction of the mesh.

In an alternative arrangement, there is provided a plurality of the two modules pivotally attached to each other to allow pivoting of the modules along the longitudinal axis of the mesh, the plurality of the two modules extending transversally along the mesh to define a row that separates the mesh into a first section of the mesh and a second section of the mesh wherein the first section is pivotally attached to the second section of the mesh to allow curving of the mesh along the longitudinal direction of the mesh.

Preferably, the sides of the mesh are slideably attached to the pylons, to allow displacing the mesh selectively between a contracted condition and an extended condition.

Preferably, there are a plurality of rows defined by the pairs of modules attached to each other to allow pivoting of the modules along the longitudinal axis of the mesh, wherein the plurality of rows are pivotally attached to each other to allow pivoting of the rows along the longitudinal axis of the mesh.

Preferably, the rows are pivotally attached to each other via first ropes extending transversally from one pylon to the other pylon.

Preferably, the first ropes are slideably attached to the pylons to allow displacing the mesh selectively between a contracted condition and an extended condition.

Preferably, the pair of modules pivotally attached to each other defining a row, are pivotally attached to each other via second ropes extending transversally along the mesh

Preferably, the outermost modules of each side of the mesh are slideably attached to third ropes, extending each third rope longitudinally adjacent to each pylon.

Preferably, each third rope is adapted to be selectively displaced between (1) an extended condition when the mesh is in the contracted condition and (2) in a contracted condition when the mesh is in the extended condition.

Preferably, a sliding ring is releasably attached to each of the pylons to allow maintaining the mesh in extended condition and to allow, after releasing of the sliding ring, the mesh to be displaced into contracted condition.

Preferably, the sliding ring is adapted to be displaced between a first and second position along the pylon to allow movement of the mesh to account for tidal changes and movement of the water.

Preferably, the sliding ring is located at an upper portion of the pylon.

According to a second aspect of the present invention there is provided a mesh for a barrier, the mesh comprising a plurality of modules adapted to be attached to each other, wherein at least two of the modules are pivotally attached to each other.

Preferably, adjacent rows of modules are pivotally attached to each other.

Preferably, adjacent columns of modules are pivotally attached to each other.

Preferably, there is provided a plurality of the two modules pivotally attached to each other, the plurality of the two modules extending longitudinally along the mesh to define a column that separates the mesh into a first section of the mesh and a second section of the mesh wherein the first section is pivotally attached to the second section to allow curving of the mesh along the transversal direction of the mesh.

Preferably, there is provided a plurality of the two modules pivotally attached to each other to allow pivoting of the modules along the longitudinal axis of the mesh, the plurality of the two modules extending transversally along the mesh to define a row that separates the mesh into a first section of the mesh and a second section of the mesh wherein the first section is pivotally attached to the second section to allow curving of the mesh along the longitudinal direction of the mesh.

Preferably, the modules define an enclosed area.

Preferably, the modules are either ring shaped, diamond shaped, hexagonal shaped, pentagonal shaped or squared shaped or any shape that encloses an area

According to a third aspect of the present invention there is a mesh for a barrier comprising a plurality of ring shaped modules, each ring shaped modules comprising a tyre bead.

Preferably, the mesh comprising a first sheet defined by first ring shaped modules and a second sheet defined by second ring shaped modules wherein the second sheet being attached adjacent and offset to the first sheet.

Preferably, the mesh further comprises connections that simultaneously join together the first and second ring shaped modules and the first and second sheet.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic front view of a particular arrangement of the barrier in accordance in accordance with the first embodiment of the invention;

FIG. 2 is a schematic top view of the barrier shown in FIG. 1;

FIG. 3 is a schematic side view of a barrier in accordance with a third embodiment of the invention;

FIG. 4 is a schematic front view of a section of a first arrangement of a mesh of the barrier shown in FIG. 1;

FIG. 5 is a schematic front view of a section of a second arrangement of the mesh of the barrier shown in FIG. 1;

FIG. 6 is a schematic front view of a first arrangement of a module of the mesh of the barrier shown in FIG. 1;

FIG. 7 is a schematic front view of a second arrangement of a module of the mesh of the barrier shown in FIG. 12;

FIG. 8 is a schematic front view of a third arrangement of a single module of the mesh of a barrier;

FIG. 9 is a plan view of a first arrangement of a male connector of the shark barrier shown in FIG. 1;

FIG. 10 is a plan view of a first arrangement of a female connector of the shark barrier shown in FIG. 1;

FIG. 11 is a plan view of a joint formed by the union of the male and female connectors shown in FIGS. 9 and 10;

FIG. 12 is a schematic perspective view of a section of a barrier in accordance with a second embodiment of the invention;

FIG. 13 is a perspective view of the pivoting joint defined by joining together two joints defined by the second arrangement of the female and male connectors shown in FIGS. 16 and 17;

FIG. 14 is a perspective view of a rivet for securing the pivoting joint together;

FIG. 15 is a perspective view of a second arrangement of a female connector and a second arrangement of a male connector prior connection to define a joint;

FIG. 16 is a perspective view of the second arrangement of the female connector shown in FIG. 13;

FIG. 17 is a perspective view of the second arrangement of the male connector shown in FIG. 13;

FIG. 18 is a close up view of a joint including a loop member for securing the mesh to a chain of the barrier in accordance with any of the first to third embodiments of the invention;

FIG. 19 is a perspective view of the loop member shown in FIG. 18;

FIG. 20 is a schematic front view of a section of a first arrangement of the mesh of a barrier shown in in accordance with the third embodiment of the invention;

FIG. 21 is a schematic side view of a section of a first arrangement of the mesh shown in FIG. 20;

FIG. 22 is a schematic top view of a pivoting joint of the mesh shown in FIG. 20 in extended condition;

FIG. 23 is a schematic top view of the pivoting joint shown in FIG. 22 in pivoted condition;

FIG. 24 is a schematic front view of a supporting pylon of the barrier shown in FIG. 3 showing a portion of the mesh in extended condition;

FIG. 25 is a schematic perspective view of a ring member of the supporting pylon shown in FIG. 24;

FIG. 26 is a schematic side view of an alternative arrangement of a pylon supporting the mesh;

FIG. 27 is a schematic plan view of a further alternative arrangement of a pylon supporting the mesh; and

FIG. 28 is a schematic front view of a particular arrangement of the barrier in accordance in accordance with the first embodiment of the invention;

### DESCRIPTION OF EMBODIMENTS

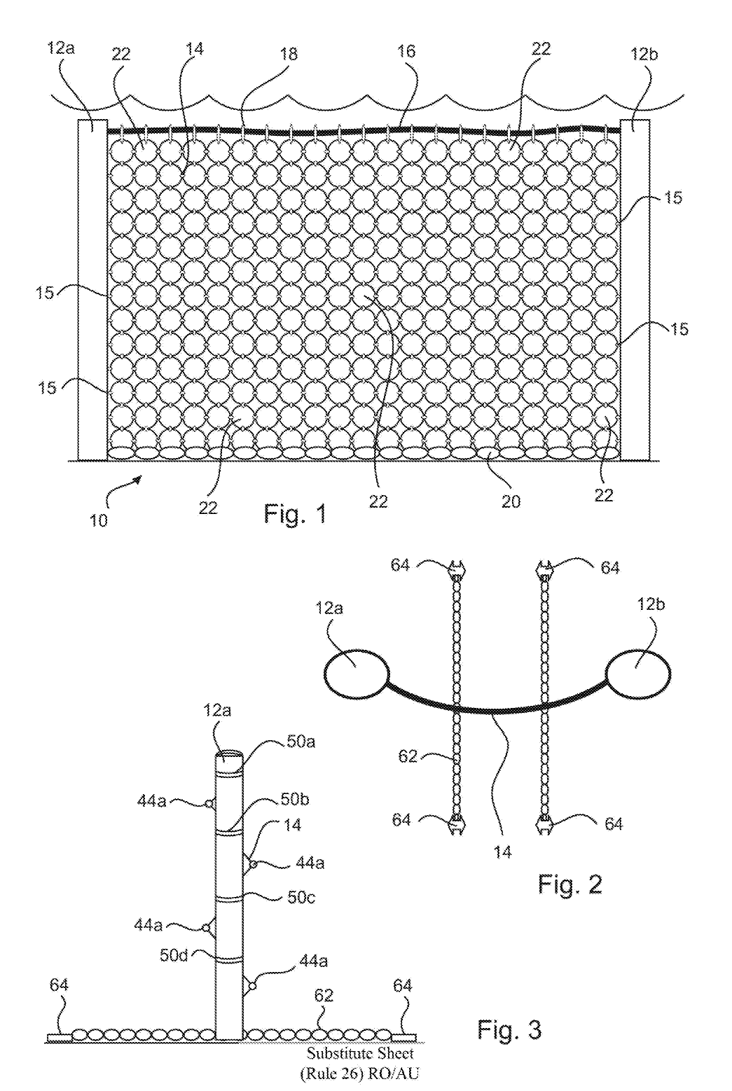

Referring to the FIG. 1, there is shown a barrier 10 comprising a plurality of pylons 12 and a mesh 14. The mesh 14 spans from one of the pylons 12a to the other pylon 12b and extends form the upper portion of the pylons 12 to the lower portion of the pylons 12. In this manner, the barrier 10 is defined which impedes marine life such as sharks to enter a particular area of the shore line. This arrangement impedes the shark traversing the space located between the pylons 12.

FIG. 2 shows a second embodiment of the present invention. This particular embodiment includes also a plurality of pylons 12 with a mesh 14 spanning between the pylons 12. In this particular embodiment, the mesh 14 is adapted to curve. The fact that the mesh 14 is adapted to curve is particularly advantageous because it allows the mesh to adjust to the movements of the water when the mesh 14 is deployed in the water.

FIG. 3 shows a third embodiment of the present invention. This particular embodiment includes also a plurality of pylons 12 with a mesh 14 spanning between the pylons 12. In this particular embodiment, the mesh 14 is adapted to be selectively displaced between an extended condition and a contracted condition. The fact that the mesh 14 is adapted be selectively displaced between an extended condition and a contracted condition is particularly advantageous because it allows to locate the mesh in the contracted condition if access through the pylons 12 is desired. Access through the pylons 12 is impeded after returning the mesh 14 to the extended condition. Furthermore, the mesh 14 in accordance with this particular embodiment is adapted to move parallel to the longitudinal axis of the pylons. This is particularly useful because it allows for the barrier to adjust the location of the mesh along the pylons 12 to account for the low and high tide.

We refer now to the barrier 10 in accordance with a first embodiment of the invention that is shown in FIG. 1.

In the particular arrangement of the barrier 10 shown in FIG. 1 each side of the mesh 14 is attached to a pylon 12. For this each side of the mesh 14 comprises connectors 15. The connecters 15 are spaced apart with respect to each other along the longitudinal axis of the pylons 12. This allows maintaining the mesh 14 between the pylons 12.

Further, the barrier includes a rope 16 that extends from an upper portion of one of the pylons 12a to an upper portion of other pylon 12b. The rope 16 supports the mesh 14 in the extended condition. For this, the upper portion of the mesh 14 is attached to the rope 16 via connectors 18.

Furthermore, the barrier 10 includes a chain 20 that extends from a lower portion of one of the pylons 12a to a lower portion of other pylon 12b. The chain 20 supports the mesh 14 between the lower portions of the pylons 12. For this, the lower portion of the mesh 14 is attached to the rope 16 via connecting means 66—see FIGS. 17 to 19.

The mesh 14 shown in FIG. 1 comprises a plurality of modules 22. The modules 22 are connected to each other defining the mesh 14. The modules 22 are secured together by connectors 24 to form a net like structure defining the mesh 14.

In the particular arrangement shown in FIG. 1, the modules 22 are configured as rings. However, in accordance with any embodiment of the present invention, the modules 22 may be configured to have any type of shape. For example, FIGS. 7 and 8 show alternative arrangements of the modules 22. FIG. 7 shows a module configured as a diamond shape body 22. FIG. 8 shows a module configured as a square shape body 22.

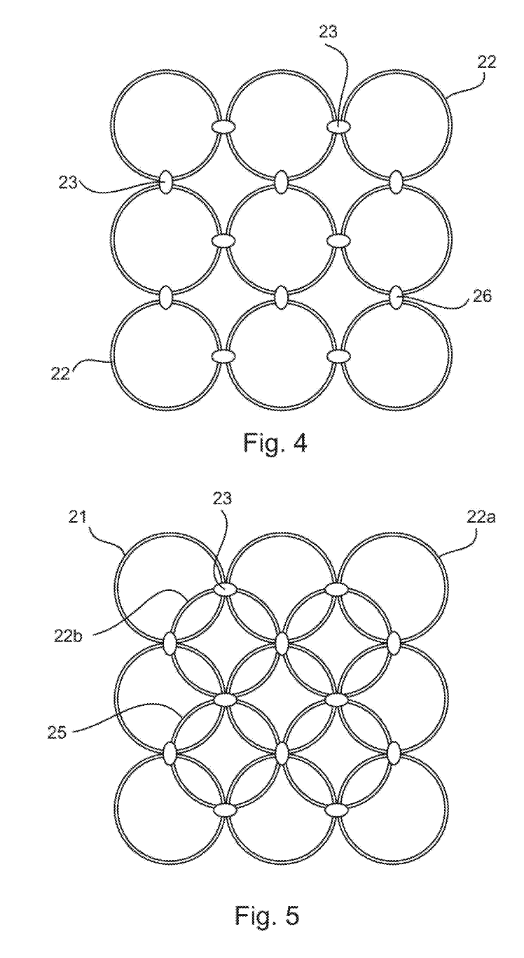

FIGS. 4 and 5 show a section of a mesh 14 including the ring shaped modules 22. The ring shaped modules 22 are attached to each other via connections 23. In a particular arrangement, the connections 23 are adapted to permit pivotal movement between the modules 22. This is particular advantageous because it allows for the mesh to adjust to water movements and tidal changes.

In particular, FIG. 5 shows a mesh 14 comprising a first sheet 21 defined by modules 22a and a second sheet 25 defined by modules 22b. The second sheet 25 being located adjacent and offset to the first sheet 21. The modules 22a and 22b of the sheet 21 and the sheet 25 are joined together via the connections 23 which also join together the first and second sheet 21 and 25.

Each of the ring shaped modules 22 may be formed of a generally rigid material. The ring shaped modules 22 are each formed of a material such that the ring shaped modules 22 are sufficiently rigid to retain a circular shape but may include some flexibility.

The ring shaped modules 22 may be formed from tyre beads. That is, the ring shaped modules 22 each comprise the bead portion of a discarded tyre separated from the tyre by cutting. Each ring shaped modules 22 therefore comprises a metallic ring coated by a rubber material. Each discarded tyre may therefore provide a pair of ring shaped modules 22 for use in the barrier 10. With such a construction, the barrier 10 can be formed of material which would otherwise need disposal and the barrier 10 can therefore be produced relatively inexpensively

Referring now to FIGS. 7 and 8. In an arrangement the diamond shaped module 22 may comprise a plurality of bars 24 connected to each other so as to define a body of any shape and surround a void area to allow fluid flow traverse the area. In alternative arrangements the modules may be defined by bars 24 connected to each other such that the bars 24 do not enclose an area.

Furthermore, in a further alternative arrangement the modules 22 may include within the area enclosed by the bars 24 second bars (not shown)—extending between the bars 24—to provide, for example, support to the modules 22.

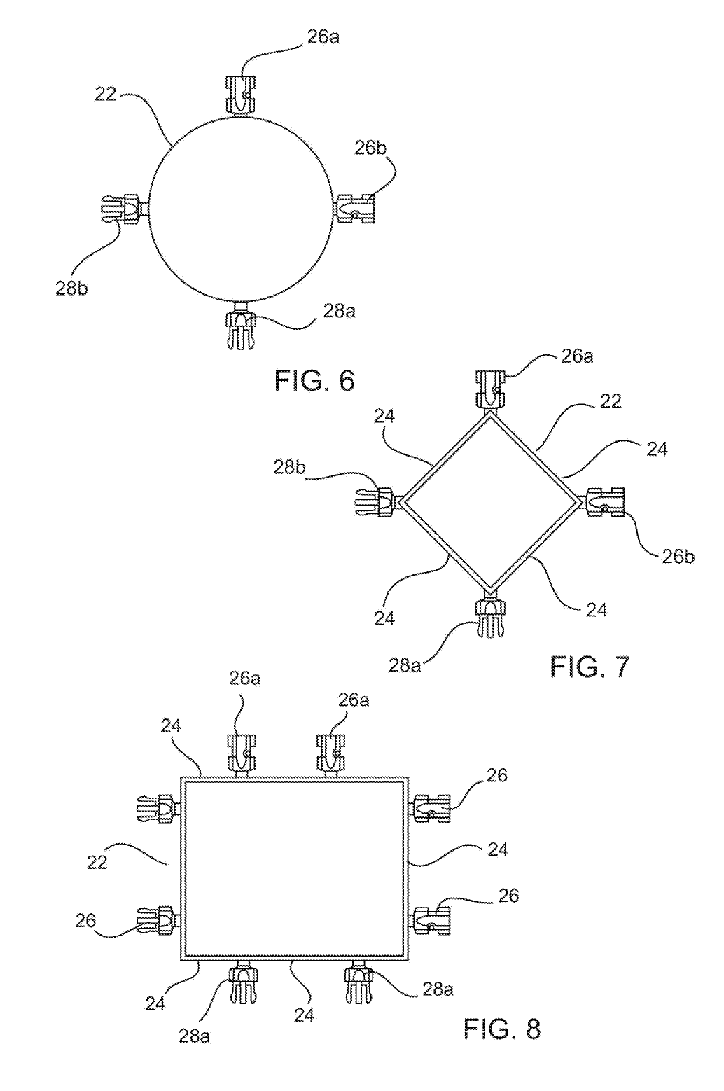

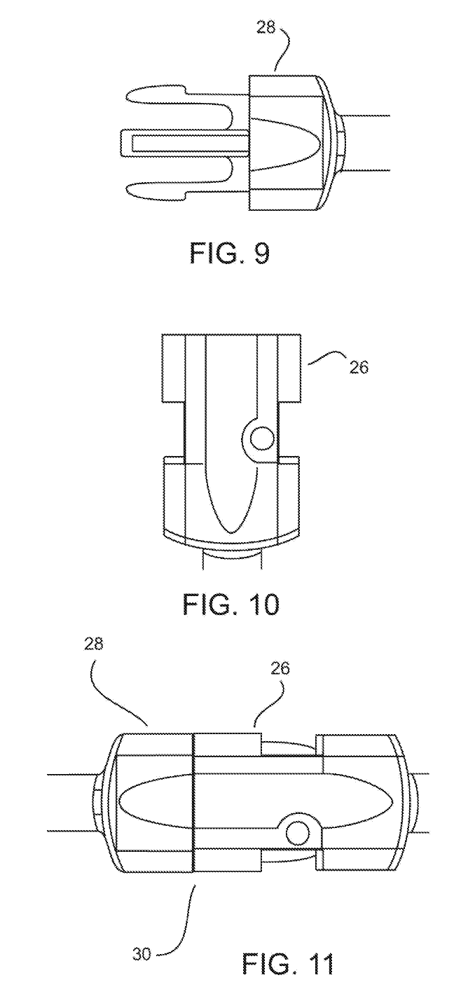

As mentioned above, the modules 22 are adapted to be joined together. For this the modules 22 comprise female connectors 26 and male connectors 28 adapted to be attached together to define a first joint 30—see FIGS. 9 to 11. In the particular arrangement shown in the FIGS. 6 to 8, the modules 22 comprises a plurality of the connectors 26 and 28 spaced apart with respect to each other. The connectors 26 and 28 are arranged in such a manner that the upper and lower side of each module 22 comprises connectors 26a and each side of the modules 22 comprise connectors 26b and 28b.

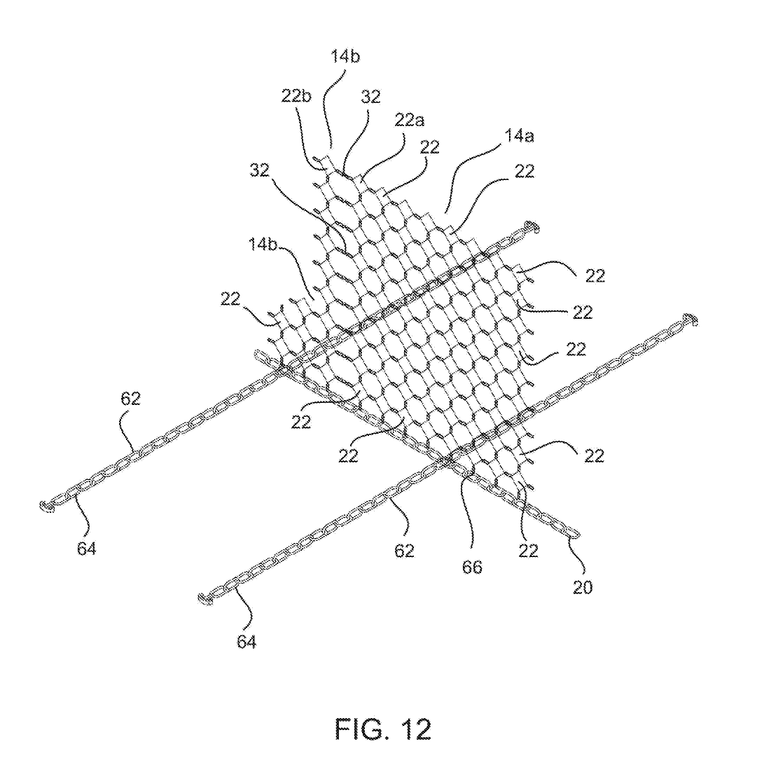

We refer now to FIG. 12. FIG. 12 shows a schematic perspective view of a section of a barrier 10 according to a second embodiment of the invention. The barrier 10 according to the second embodiment is similar to the barrier 10 according to the barrier 10 of the first embodiment and similar reference numerals are used to identify similar parts. In this second embodiment of the invention, the modules 22 are adapted to be pivotally joined together. As will be explained with reference to the method of operation of the barrier 10 the fact that the modules 22 are adapted to be pivotally joined together is particularly advantageous because it allows the barrier 10 to adjust to account for the movement of the water contained in the body of water in which the barrier 10 is immersed or partially immersed.

The mesh 14 depicted in FIG. 12, comprises a plurality of modules 22 configured as a diamond shaped body. In the particular arrangement, shown in FIG. 12, the mesh 14 comprises a first section 14a and a second section 14b. The sections 14a and 14b are joined together via pivoting joints 32. As shown in FIG. 12, each of the outermost modules 22a and 22b of each section 14a and 14b are joined together by a pivoting joint 32. In this manner, a column is defined between the sections 14a and 14b. The column comprises a plurality pivoting joints 32 that extend from the upper portion of the mesh 14 to the lower portion of the mesh 14. The fact that the sections 14a and 14b of the mesh are pivotally joined together is particular advantageous because it allows the mesh 14 to curve along the transversal direction of the mesh as is, for example, shown in FIG. 2. This allows the mesh 14 to adjust to movements of the water of the body of water in which the barrier 10 is immersed.

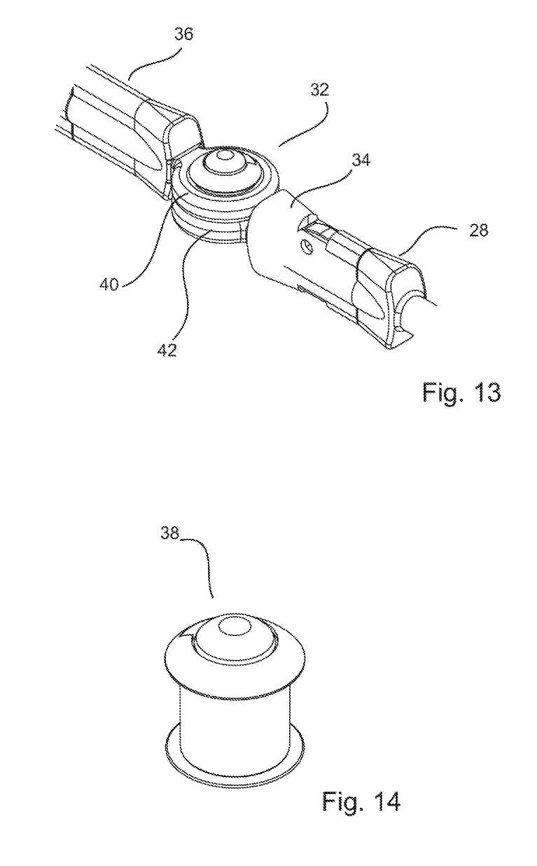

FIG. 13 show a particular arrangement of the pivoting joint 32. The pivoting joint 32 comprises a female connector 34 and a male connector 36. The female and male connectors 34 and 36 are joined together via a rivet 38 allowing the pivoting joint 32 to pivot.

Each of the female and male connectors 34 and 36 comprise a ring member 40. To connect the female and male connectors 34 and 36 together the ring members 40 are joined together in such manner that the rivet 38 traverses simultaneously both ring members 40—see FIG. 13. This allows forming the pivoting joint 32.

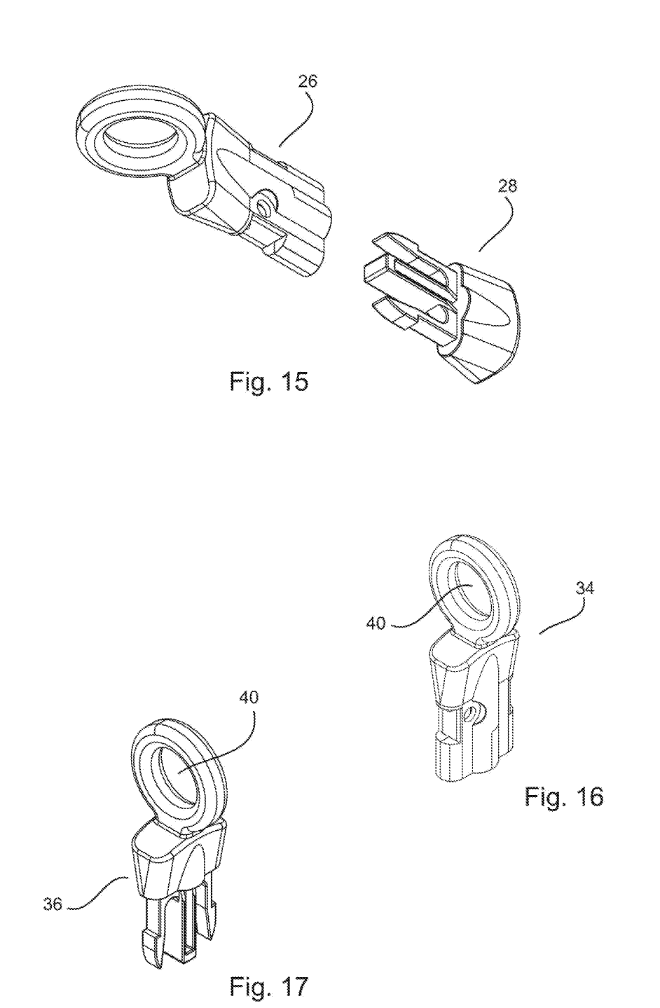

The pivoting joint 32 is attached to the modules 22 located adjacent to each other by fastening the pivoting joint 32 to the connectors 26 and 28 of the modules 22. As shown in FIGS. 13 and 15, the female connector 34 is attached to the male connector 28 of the module 22a. Similarly, the male connector 36 is attached to the female connector 26 of the module 22b.

In the particular arrangement shown in FIG. 12, the mesh 14 comprises a pair of sections 14a and 14b. However, in alternative arrangements, the mesh 14 may comprise more than two sections 14a and 14b joined together by pivoting joints 32.

In further alternative arrangements, each of the modules may be attached to each other via pivoting joints 32. For example, in a particular arrangement, each side of a module 22 may be pivotally joined together to its neighbouring module 22 via pivoting joint 32.

Furthermore, the upper and lower ends of the each module 22 may be pivotally attached to the upper and lower ends of a further module 22 located adjacent to the each module 22. This allows for curving of the mesh along the longitudinal direction of the mesh 14. And, as will be described with reference to the third embodiment of the invention, this particular arrangement of the invention is particularly advantageous because in some particular arrangements of the barrier it allows the mesh 14 to be selectively displaced between an extended condition and a contracted condition.

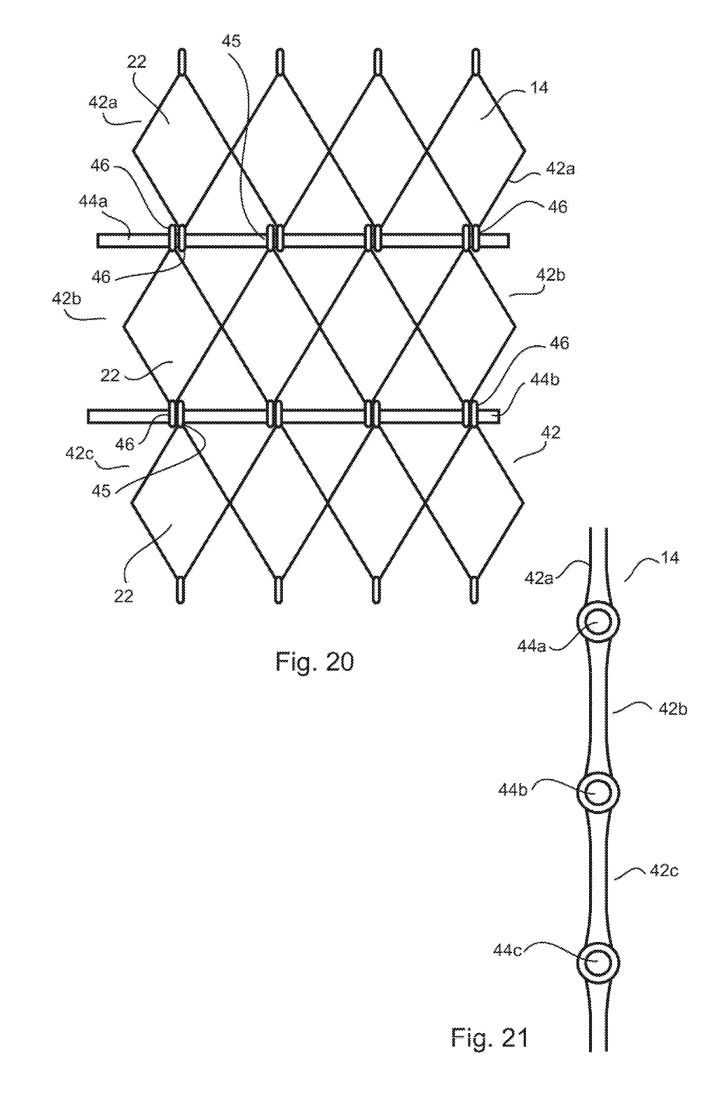

We refer now to FIGS. 20 to 29. These figures relate to a barrier 10 according to the third embodiment of the invention. The third embodiment is similar to the barrier 10 according to the barrier 10 of the first and second embodiments and similar reference numerals are used to identify similar parts. As mentioned in the previous paragraph, in this third embodiment of the invention, the modules 22 are adapted to be pivotally joined together to allow the mesh to be selectively displaced between an extended condition and a contracted condition. The fact that the mesh 14 is adapted to be selectively displaced between an extended condition and a contracted condition is particularly advantageous because it allows locating the mesh 14 in the contracted condition to permit access to the particular area of the shore line which access was impeded due to deployment of the mesh 14. By returning the mesh 14 to the extended condition access to the particular area of the shore line may be impeded again.

FIGS. 20 and 21 show a particular arrangement of a section of the mesh 14 in accordance with a third embodiment of the invention. In this particular arrangement of this embodiment of the invention, the mesh comprises a plurality of rows 42a, 42b and 42c. Each row 42 comprises a plurality of modules 22 arranged side by side transversally along the mesh 14. The rows 42 are arranged adjacent to each other longitudinally along the mesh 14. The rows 42 are joined together via ropes 44. The ropes 44 extend from one side of the mesh 14 to the other side of the mesh.

The modules 22 are pivotally attached to the ropes 44. For this, the modules 22 comprise connectors 46. The connectors 46 comprise ring members 48 adapted to receive the rope 44. This arrangement allows pivotally attaching adjacent rows 42 to each other. In this manner, the mesh 14 may be selectively displaced between the extended condition and the contracted condition.

As shown in FIG. 20, when the mesh is assembled, the ring member 40 of each module 22 of a particular row 42a is located side by side of the ring member 40 of each module of the particular row 42b that is located adjacent to the lower portion of the row 42a. The same applies to the connection of row 42b and 42c. FIG. 20 shows a particular section of the mesh 14 in accordance with a third embodiment of the invention; thus, a mesh 14 in accordance with a third embodiment of the invention may include more than three rows 42a, 42b and 42c—each of the adjacent rows 42 being pivotally attached to each other.

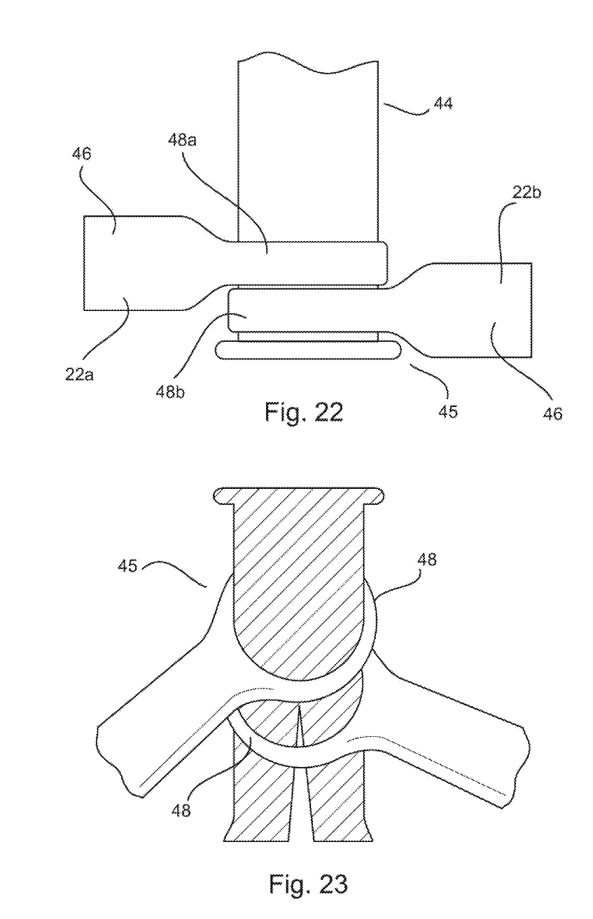

Referring now to FIG. 22, FIG. 22 shows the pivot connection 45 of two modules 22a and 22b. In particular, FIG. 22 shows the pivot connection 45 of the outermost modules of the mesh 14. As shown the ring members 48 are located side by side to allow the rope 44 to traverse both ring members 48a and 48b. This particular arrangement allows for pivotal movement between adjacent modules 22a and 22b—see FIG. 23.

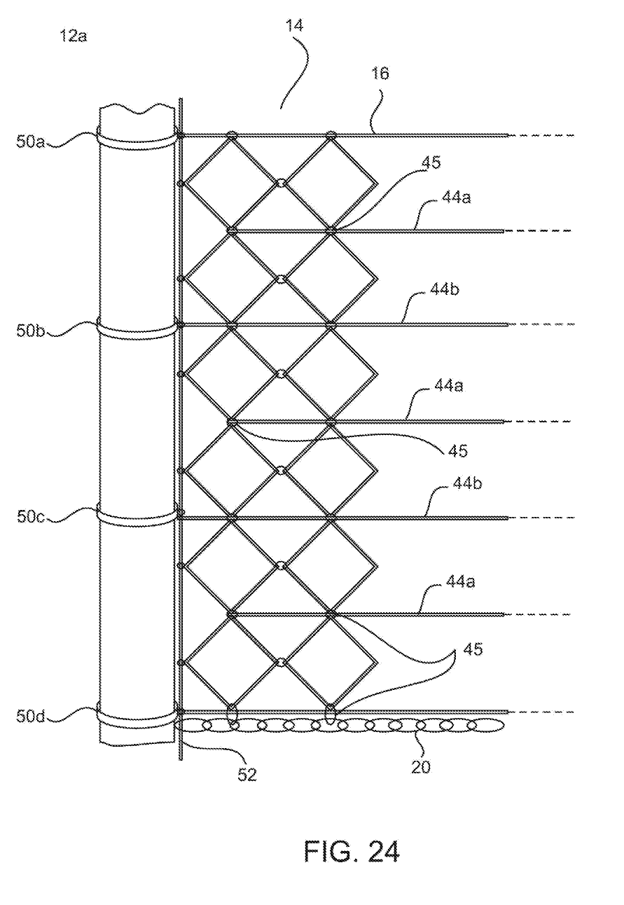

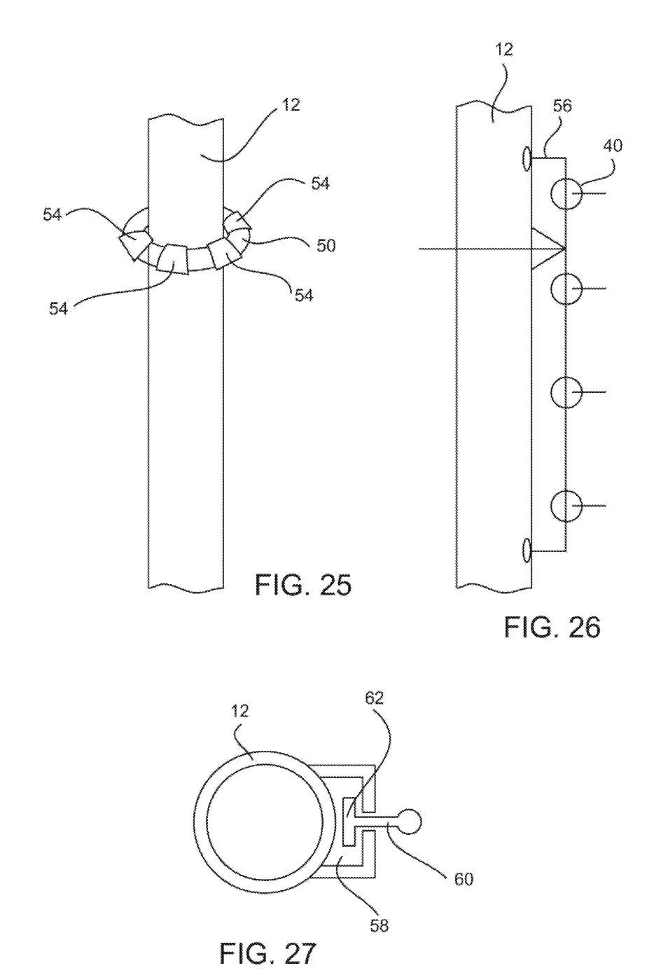

We refer now to the FIGS. 25 and 26. As mentioned before, the mesh 14 spans between pylons 12a and 12b defining the barrier 10. FIGS. 25 and 26 show a section of the barrier 10. In particular, in FIGS. 25 and 26 depict the left portion of a barrier 10 in accordance with the third embodiment of the invention and as shown, for example, in FIG. 3. As shown in FIG. 24, the mesh 14 comprises a plurality of rows of modules 22. As mentioned before FIGS. 25 and 26 are schematic views of a section of the barrier 10—in particular, FIGS. 25 and 26 depict a section of the mesh having three rows of modules 22; each row having two modules 22. However, the mesh 14 may include a plurality of row extending from an upper portion of the pylon 12 to a lower portion of the pylon 12. Also, the barrier 10 may include a plurality of modules 22 extending from the pylon 12a to the other pylon 12b.

As shown in the particular arrangement depicted in FIG. 24, the mesh 14 is attached to the pylons 12 via sliding rings 50. In the arrangement shown in FIGS. 25 and 26 there are provided an upper sliding ring 50a. To the sliding ring 50a is attached the rope 16. The sliding ring 50a is adapted to be releasably attached to the pylon 12. In this manner, the sliding ring 50a may be fastened to the pylon 12 in order to maintain the mesh 14 in the extended condition. For locating the mesh 14 in the contracted condition the sliding ring 50a may be detached from the pylon 12a to allow the ring 50a to slide along the longitudinal axis of the pylon together with the remaining rings 50. In this manner, the mesh 14 may be located in the contracted condition.

However, in a particular arrangement, the sliding ring 50a may be attached to the pylon 12 in such a manner that the sliding ring 50a may be displaced due to tidal changes. For example, the sliding ring may be allowed to slide a specific distance along the pylon 12. This is accomplished by setting upper and lower means for stopping the sliding ring 50a. This is particularly advantageous because it allows to account for these tidal changes.

The lower means for stopping the sliding ring 50a may be adapted to allow the sliding ring 50a to travel beyond the lower stopping means to allow the sliding ring 50a to descent longitudinally along the pylon 12 during contraction of the mesh 14.

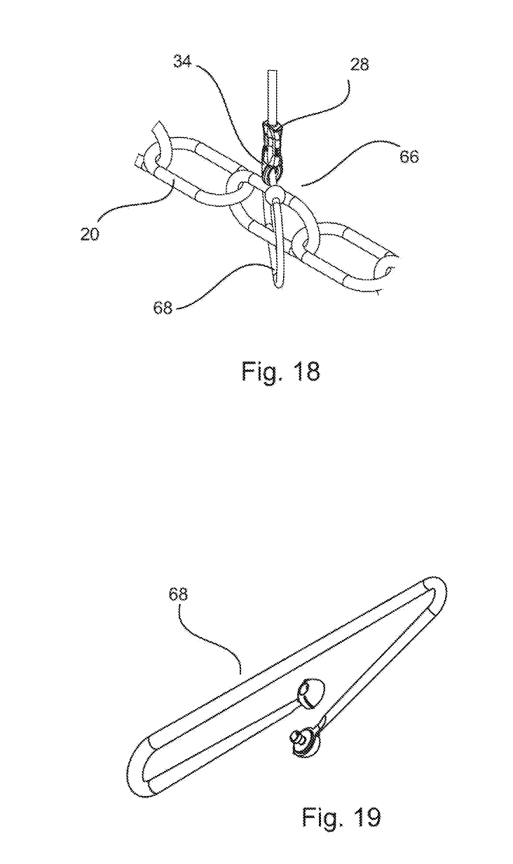

Referring back to the mesh 14, as mentioned before each module 22 is pivotally attached to its adjacent module (upper and lower modules 22) via pivot connections 45—see FIGS. 20 to 23 except for the upper most row of modules 22 and the lowermost row of modules 22. The modules 22 of the uppermost row are pivotally attached to the rope 16 through, for example, rings 40 of connecting members 34 or 36. The modules 22 of the lowermost row are pivotally attached to the chain 30 through, for example, rings 40 of connecting members 34 or 36—see FIGS. 12 and 18.

As was described before, the mesh 14 is adapted to be selectively displaced between the extended condition and the contracted condition. For this, the rope 16 and a group of ropes 44b are attached each to a sliding ring 50 and another group of ropes 44a that are not attached to a sliding ring 50. This arrangement allows for the mesh 14 to be selectively displaced between the extended condition and the contracted condition.

In the particular arrangement shown in FIG. 24, the ropes 44b that are attached to the sliding ring 50 are selected such that two rows of modules 22 are located between two ropes 44b that are attached to the sliding ring. In this manner, one rope 44a that is not attached to the sliding ring 50 is located between two ropes 44b that are attached to a sliding ring 50.

Further, the barrier 10 comprises a rope 52 that extends adjacent and longitudinally to the pylon 12. The modules 22 of the outermost column are slideably attached to the rope 52 to maintain the sides of the mesh 14 close to the pylon. The rope 52 comprises a flexible rope 50 that extends selectively between an contracted condition (when the mesh 14 is in the extended condition) and an extended condition (when the mesh 14 is in the contracted condition)

In a particular arrangement, the modules 22 of the outermost columns defining the sides of the mesh 14 may be slideably attached to the rope 52 via the connecting members 34 or 36—see FIGS. 16 and 17. As discussed, the connecting members 34 and 36 comprise ring members 40 that can be traversed by the rope 52.

FIG. 25, shows a schematic view of one of the sliding ring 50. In this particular arrangement the sliding ring 50 incorporates a plurality of rollers 54 that are arranged in a spaced apart relationship around the sliding ring 50. The rollers 54 facilitate sliding of the ring 50 longitudinally along the pylon 12.

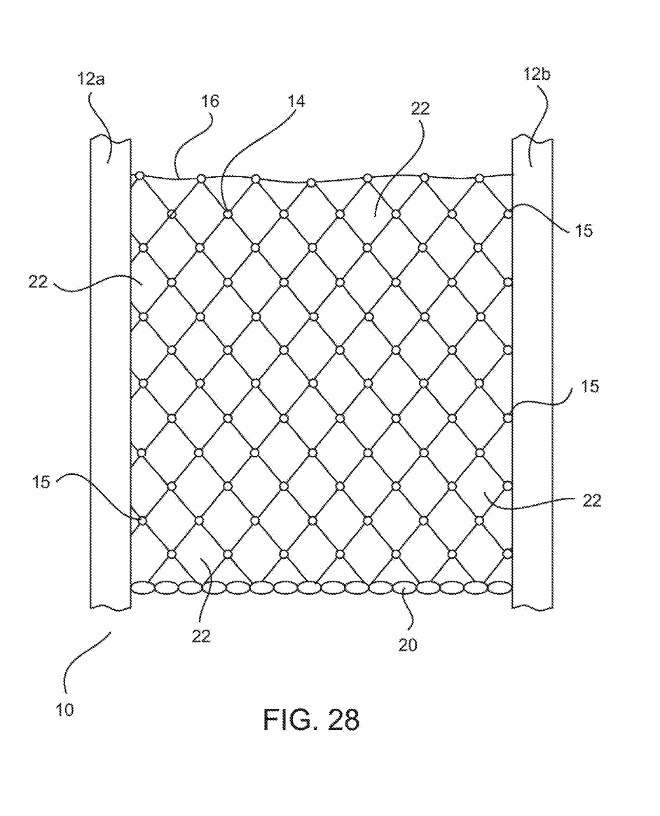

Further, FIGS. 28 and 29 show an alternative arrangement of pylon 12 adapted to allow selective displacement of the mesh 14 between the extended condition and the contracted condition. In particular, FIG. 26 shows a pylon 12 incorporating a bar 56 that extends outward from the pylon 12. The bar 56 is adapted to receive the rings 40 of the connecting members 34 or 36 of the modules 22 in such a manner that the rings 40 may slide longitudinally along the bar 56 during the process of extending or contracting of the mesh 14. FIG. 27 shows a pylon 12 incorporating a channel 58 that extends longitudinally along the pylon 12. The bar 56 is adapted to receive guides 62 (that are attached to the modules 22) in such a manner that the guides 62 may slide longitudinally along the bar 56 during the process of extending or contracting of the mesh 14.

Referring now back to FIG. 12. The barrier 10 is secured to the seabed via chains 62. In the particular arrangement shown in FIG. 12 there are two chains 62 spaced with respect to each other.

The chains 62 rest on the seabed extending perpendicularly to the mesh 14. The chains 62 comprise, at each end, anchors 64 to maintain the chains 62 attached to the seabed. The chain 20 may be fastened to the chain 62 to secure the mesh 14 to the chain 62.

The lowermost row of modules 22a is attached to the chain 20. In the particular arrangement shown in the figures a particular module 22 is attached to the chain 20. However, in alternative arrangements, each of the modules 22 of the lowermost row of the mesh structure 11 may be attached to the chain 20 via connecting means 66.

FIGS. 18 and 19 show the connecting means 66. As shown in FIG. 18, the connecting means 66 comprise a loop member 68. The loop member 68 is adapted to be selectively closed and opened to allow fastening of the loop member to the chain 20 and to allow the connecting member 34 or 36 to be attached to the loop member 68 via its ring member 40.

It is evident that the present embodiments of the invention provide an effective and useful barrier 10 for, for example, marine life such as sharks.

The barrier 10 may be assembled by locating pylons 12 in the seabed spaced apart with respect to each other to allow the mesh 14 extend between the pylons 12. The lower chain 20 and the upper rope 16 may be extended between the pylons 12.

Once, the pylons 12 are set in the seabed, the assembly of the mesh 14 may proceed. It is expected that the mesh 14 will be assembled, for example, on a barge in the location where the barrier 10 is to be placed. The modules 22 can be joined together by connecting the respective connecting members 26 and 28. The modules 22 are joined together in such a manner so as to define the shape of the mesh that is required. After having connected the modules 22 together, the connecting members 34 or 36 (incorporating the rings 40) may be attached to the connecting members 26 or 28 of the modules 22 of the uppermost and lower most row of modules 22 and the outermost side columns of modules 22 of the mesh 14.

In particular, connecting members 34 or 36 (incorporating the rings 40) are connected to the connecting member 26 or 28 of each module 22 of the uppermost row of modules 22. This allows for fastening the mesh 14 to the rope 16 which allows maintaining the mesh 14 in the extended condition.

Further, connecting members 34 or 36 (incorporating the rings 40) are connected to the connecting member 26 or 28 of each module 22 of the outermost columns of the mesh 14. This allows fastening the sides of the modules 22 to the pylons 12. In the particular arrangement described with reference to the third embodiment, the rings 40 of the connecting members 34 or 36 will be attached to either (1) the sliding rings 50 or (2) the rope 52 that maintains the side of the mesh 14 close to the pylon 12. Further, connecting members 34 or 36 (incorporating the rings 40) are connected to the connecting members 26 or 28 of the respective modules 22 of the lowermost row of the mesh 14 that will be connected via the connecting means 66 to the chain 20.

After the assembly process of the mesh 14 has been completed the mesh 14 is lowered into place from the barge. At the location, the mesh 14 is connected to the pylons 12, upper rope 16 and lower chain 20 as was previously described in order to define the barrier 10 and impede access to the particular location.

The barrier 10 may extend along a portion of shoreline parallel to the shore and also have end portions that extend inwardly to the shore to define a completely enclosed area.

The size of the modules 22 will impede relative large marine life, such as sharks, access to the particular area of the shoreline while allowing smaller marine life to simply swim through the modules 22 of the mesh 14. The particular construction of the mesh 14 may limit any entanglement of marine life.

And, as described with reference to the present embodiment of the invention mesh 14 is adapted to accommodate tidal changes and movement of the water in view that, for example, the modules 22 may be pivotally attached to each other and the mesh may slide along the longitudinal axis of the pylons. The mesh 14 may also be selectively displaced between an extended condition and contracted condition.

Throughout this specification, unless the context requires otherwise, the word “comprise” or variations such as “comprises” or “comprising”, will be understood to imply the inclusion of a stated integer or group of integers but not the exclusion of any other integer or group of integers

1. A barrier comprising a plurality of pylons spaced apart with respect to each other, and a mesh extending between the pylons wherein the mesh comprises a plurality of modules adapted to be attached to each other.

2. A barrier according to claim 1 wherein the barrier further comprises a rope extending between the pylons for attachment of an upper portion of the mesh to maintain the mesh in the extended condition.

3. A barrier according to claim 1 or 2 wherein the barrier further comprises a first chain extending between the pylons for attachment of a lower portion of the mesh to secure the mesh to a lower portion of the barrier.

4. A barrier according to any one of the preceding claims wherein at least one module of the mesh is attached to the first chain.

5. A barrier according to any one of the preceding claims wherein the barrier comprises means for anchoring the barrier to the seabed.

6. A barrier according to claim 5 wherein the means for anchoring the barrier comprises at least one second chain, the second chain being anchored to the seabed at locations distal to the barrier.

7. A barrier according to claim 6 wherein the second chain extends perpendicular to the barrier.

8. A barrier according to claim 6 or 7 wherein the second chain comprises two ends, the two ends being anchored to the seabed via anchors.

9. A barrier according to any one of claims 6 to 8 wherein the second chain is attached to the first chain of the barrier.

10. A barrier according to any one of the preceding claims wherein the mesh is adapted to account for movement of water in which the barrier is at least partially immersed.

11. A barrier according to any one of the preceding claims wherein at least two modules are pivotally attached to each other.

12. A barrier according to any one of the preceding claims wherein adjacent rows of modules are pivotally attached to each other.

13. A barrier according to any one of the preceding claims wherein adjacent columns of modules are pivotally attached to each other.

14. A barrier according to claim 13 wherein there is provided a plurality of the two modules pivotally attached to each other, the plurality of the two modules extending longitudinally along the mesh to define a column that separates the mesh into a first section of the mesh and a second section of the mesh wherein the first section is pivotally attached to the second section of the mesh to allow curving of the mesh along the transversal direction of the mesh.

15. A barrier according to claim 13 wherein there is provided a plurality of the two modules pivotally attached to each other to allow pivoting of the modules along the longitudinal axis of the mesh, the plurality of the two modules extending transversally along the mesh to define a row that separates the mesh into a first section of the mesh and a second section of the mesh wherein the first section is pivotally attached to the second section of the mesh to allow curving of the mesh along the longitudinal direction of the mesh.

16. A barrier according to claim 15 wherein the sides of the mesh are slideably attached to the pylons, to allow displacing the mesh selectively between a contracted condition and an extended condition.

17. A barrier according to claim 15 or 16 wherein there are a plurality of rows defined by the pairs of modules attached to each other to allow pivoting of the modules along the longitudinal axis of the mesh, wherein the plurality of rows are pivotally attached to each other to allow pivoting of the rows along the longitudinal axis of the mesh.

18. A barrier according to claim 17 wherein the rows are pivotally attached to each other via first ropes extending transversally from one pylon to the other pylon.

19. A barrier according to claim 19 wherein the first ropes are slideably attached to the pylons to allow displacing the mesh selectively between a contracted condition and an extended condition.

20. A barrier according to claim 13 wherein the pair of modules pivotally attached to each other defining a row, are pivotally attached to each other via second ropes extending transversally along the mesh

21. A barrier according to claim 20 wherein the outermost modules of each side of the mesh are slideably attached to third ropes, extending each third rope longitudinally adjacent to each pylon.

22. A barrier according to claim 21 wherein each third rope is adapted to be selectively displaced between (1) an extended condition when the mesh is in the contracted condition and (2) in a contracted condition when the mesh is in the extended condition.

23. A barrier according to claim 22 wherein a sliding ring is releasably attached to each of the pylons to allow maintaining the mesh in extended condition and to allow, after releasing of the sliding ring, the mesh to be displaced into contracted condition.

24. A barrier according to claim 23 wherein the sliding ring is adapted to be displaced between a first and second position along the pylon to allow movement of the mesh to account for tidal changes and movement of the water.

25. A barrier according to claim 23 or 24 wherein the sliding ring is located at an upper portion of the pylon.

26. A mesh for a barrier, the mesh comprising a plurality of modules adapted to be attached to each other, wherein at least two of the modules are pivotally attached to each other.

27. A mesk according to claim 26 wherein adjacent rows of modules are pivotally attached to each other.

28. A mesh according to claim 26 or 27 wherein adjacent columns of modules are pivotally attached to each other.

29. A mesh according to claim 26 wherein there is provided a plurality of the two modules pivotally attached to each other, the plurality of the two modules extending longitudinally along the mesh to define a column that separates the mesh into a first section of the mesh and a second section of the mesh wherein the first section is pivotally attached to the second section to allow curving of the mesh along the transversal direction of the mesh.

30. A mesh according to claim 26 wherein there is provided a plurality of the two modules pivotally attached to each other to allow pivoting of the modules along the longitudinal axis of the mesh, the plurality of the two modules extending transversally along the mesh to define a row that separates the mesh into a first section of the mesh and a second section of the mesh wherein the first section is pivotally attached to the second section to allow curving of the mesh along the longitudinal direction of the mesh.

31. A mesh according to any one of claims 26 to 30 wherein the modules define an enclosed area.

32. A mesh according to claim 31 wherein the modules are either ring shaped, diamond shaped, or squared shaped or any shape the encloses an area

33. A mesh for a barrier comprising a plurality of ring shaped modules, each ring shaped modules comprising a tyre bead.

34. A mesh according to claim 33 wherein the mesh comprises a first sheet defined by first ring shaped modules and a second sheet defined by second ring shaped modules wherein the second sheet being attached adjacent and offset to the first sheet.

35. A mesh according to claim 34 wherein the mesh further comprises connections that simultaneously join together the first and second ring shaped modules and the first and second sheet.
